(19) United States
(12) Patent Application Publication
(10) Pub. No.: US 2010/0177827 A1
(43) Pub. Date: Jul. 15, 2010

(54) SUB-PIXEL GENERATING APPARATUS, SUB-PIXEL GENERATING METHOD AND STORAGE MEDIUM, AS WELL AS MOTION COMPENSATING APPARATUS

(75) Inventor: Milosz Gabriel SROKA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/609,356

(22) Filed: Oct. 30, 2009

(30) Foreign Application Priority Data
Jan. 9, 2009 (JP) 2009-004062

(51) Int. Cl. H04N 11/02

(52) U.S. Cl. 375/240.17; 375/240.16; 375/E07.001

(57) ABSTRACT

A sub-pixel generating apparatus includes a first and a second calculating sections configured to execute an average value calculation for pixel values of a plurality of pixels in an image, with a round-up process and with a round-down process, respectively; and a selecting section configured to generate an interpolated pixel, by at least one selection process among a first selection process configured to select the round-up process or the round-down process depending on a position of the interpolated pixel, a second selection process configured to select the round-up process or the round-down process for each coding prediction method, and a third selection process configured to select the round-up process or the round-down process for each average value calculation if the interpolated pixel is obtained by a plurality of the average value calculations.

### CROSS REFERENCE TO RELATED APPLICATION

This application is based upon and claims the benefit of priority from the prior Japanese Patent Application No. 2009-004062 filed in Japan on Jan. 9, 2009, the entire contents of which are incorporated herein by reference.

### BACKGROUND OF THE INVENTION

1. Field of the Invention

The present invention relates to a sub-pixel generating apparatus, a sub-pixel generating method and a storage medium, as well as a motion compensating apparatus, which are configured to obtain a sub-pixel by an average value calculation.

2. Description of Related Art

In recent years, along with popularization of MPEG (Moving Picture Experts Group), H.264 and the like, images have been digitalized. In a coding system of the MPEG or the like, a coded stream is obtained by applying a DCT process to a video signal in units of blocks to quantize the video signal, and further applying a variable length coding process to the video signal by using a predetermined variable length coding table. Moreover, an encoder of the MPEG or the like can also apply prediction coding to an inputted video signal. Furthermore, the encoder employs motion-compensated prediction coding configured to predict a motion of the image to obtain a prediction error, in order to reduce an amount of information on the prediction error.

In a moving image decoding apparatus configured to decode such a coded stream which has been inter-coded (inter-frame coded), an original image is decoded by adding the prediction error and a reference image.

Coding and decoding processes are performed in units of areas of a predetermined number of pixels, which are referred to as “macro-blocks”. The moving image decoding apparatus reads the area based on a motion vector, from the reference image stored in a memory, in units of macro-blocks, adds a read reference image macro-block and a prediction error macro-block, and thereby restores an original macro-block.

A processing amount in a motion compensating apparatus configured to obtain a motion-compensated reference image occupies a large part of an entire processing amount in moving image coding and decoding apparatuses. In addition, in the MPEG or the like, the motion vector is used not only with precision (hereinafter, referred to as “integer pixel precision”) corresponding to a pixel position of the reference image (hereinafter, referred to as “integer pixel position”), but also with precision (hereinafter, referred to as “fractional pixel precision”) corresponding to a position of a pixel (sub-pixel) between pixels of the reference image (hereinafter, referred to as “fractional pixel position”). A calculation amount in the motion compensating apparatus is extremely large.

Consequently, in order to reduce the processing amount in the motion compensating apparatus, Japanese Patent Application Laid-Open Publication No. 2008-187727 has disclosed an approach in which the sub-pixel that is the pixel with the fractional pixel precision is obtained by weighted average. However, the above proposed approach has a disadvantage that rounding errors are accumulated due to a process configured to repeat the weighted average.

In order to prevent the accumulated errors in such a motion compensation process, in a proposal of Japanese Patent Application Laid-Open Publication No. 2008-160877 (hereinafter, “Document 1”), a proposal that the accumulation of the rounding errors is suppressed by alternately performing round-up or round-down for a frame which is cumulatively referred to has been disclosed.

However, in Document 1, since a rounding direction is switched for each frame, the rounding errors may be accumulated for a pattern portion which is minutely vibrating or the like. In order to prevent the accumulation thereof, Document 1 has further proposed a method configured to multiplex an error difference related to the rounding direction. However, significant reduction of the calculation amount cannot be expected by the above method.

Moreover, conventionally, in the decoding apparatus, in order to reduce an operation amount, half-decoding configured to thin an image, for example, to ½ in a horizontal direction and decode the image may be employed. In the present case, even if the motion vector has precision (hereinafter, referred to as “½ pixel precision”) corresponding to an intermediate position between the pixels of the reference image (½ pixel position), an actual calculation is performed with precision (hereinafter, referred to as “¼ pixel precision”) corresponding to a ¼ position between the pixels of the reference image (¼ pixel position). Therefore, the errors may further increase.

### BRIEF SUMMARY OF THE INVENTION

A sub-pixel generating apparatus of an aspect of the present invention includes a first calculating section configured to execute an average value calculation for pixel values of a plurality of pixels in an image, with a round-up process; a second calculating section configured to execute the average value calculation for the pixel values of the plurality of pixels in the image, with a round-down process; and a selecting section configured to generate an interpolated pixel to be interpolated in the image, by at least one selection process among a first selection process configured to select the round-up process or the round-down process depending on a position of the interpolated pixel, a second selection process configured to select the round-up process or the round-down process for each coding prediction method set for the image, and a third selection process configured to select the round-up process or the round-down process for each average value calculation if the interpolated pixel is obtained by a plurality of the average value calculations.

Moreover, a sub-pixel generating method of an aspect of the present invention is a sub-pixel generating method configured to generate an interpolated pixel to be interpolated in an image, by a first calculating section configured to execute an average value calculation for pixel values of a plurality of pixels in the image, with a round-up process, and a second calculating section configured to execute the average value calculation for the pixel values of the plurality of pixels in the image, with a round-down process, wherein the interpolated pixel is generated by at least one selection process among a first selection process configured to select the round-up process or the round-down process depending on a position of the interpolated pixel, a second selection process configured to select the round-up process or the round-down process for each coding prediction method set for the image, and a third selection process configured to select the round-up process or the round-down process for each average value calculation if the interpolated pixel is obtained by a plurality of the average value calculations.

Moreover, in a computer-readable storage medium including a program of an aspect of the present invention, the program is configured to cause a computer to execute a process configured to generate an interpolated pixel to be interpolated in an image, by a first calculation process configured to execute an average value calculation for pixel values of a plurality of pixels in the image, with a round-up process, and a second calculation process configured to execute the average value calculation for the pixel values of the plurality of pixels in the image, with a round-down process, wherein the program is configured to cause the computer to execute the process configured to generate the interpolated pixel by at least one selection process among a first selection process configured to select the round-up process or the round-down process depending on a position of the interpolated pixel, a second selection process configured to select the round-up process or the round-down process for each coding prediction method set for the image, and a third selection process configured to select the round-up process or the round-down process for each average value calculation if the interpolated pixel is obtained by a plurality of the average value calculations.

Moreover, a motion compensating apparatus of an aspect of the present invention includes a sub-pixel generating apparatus including a first calculating section configured to execute an average value calculation for pixel values of a plurality of pixels in an image, with a round-up process; a second calculating section configured to execute the average value calculation for the pixel values of the plurality of pixels in the image, with a round-down process; and a selecting section configured to generate an interpolated pixel to be interpolated in the image, by at least one selection process among a first selection process configured to select the round-up process or the round-down process depending on a position of the interpolated pixel, a second selection process configured to select the round-up process or the round-down process for each coding prediction method set for the image, and a third selection process configured to select the round-up process or the round-down process for each average value calculation if the interpolated pixel is obtained by a plurality of the average value calculations; a memory controlling section configured to read a reference image from a reference image memory based on a motion vector extracted from a coded stream applied with motion-compensated prediction coding, and give the reference image to the first and second calculating sections; and a controlling section configured to give the motion vector extracted from the coded stream, to the selecting section for the first selection process, give information on the coding prediction method extracted from the coded stream, to the selecting section for the second selection process, and give information on a frame number extracted from the coded stream, to the selecting section for the third selection process.

### BRIEF DESCRIPTION OF THE DRAWINGS

FIG. 1 is a block diagram showing a sub-pixel generating apparatus according to an embodiment of the present invention;

FIG. 2 is a block diagram showing a configuration of a moving image decoding apparatus in which a motion compensating apparatus has been incorporated, according to an embodiment of the present invention;

FIG. 3 is a block diagram showing an example of a specific configuration of a motion compensating apparatus 13;

FIG. 4 is an explanatory diagram for explaining a sub-pixel generating apparatus 22;

FIG. 5 is an explanatory diagram for explaining the sub-pixel generating apparatus 22; and

FIG. 6 is a block diagram showing a sub-pixel generating apparatus 30 configured to realize a process shown in FIG. 5 by software.

### DETAILED DESCRIPTION OF THE INVENTION

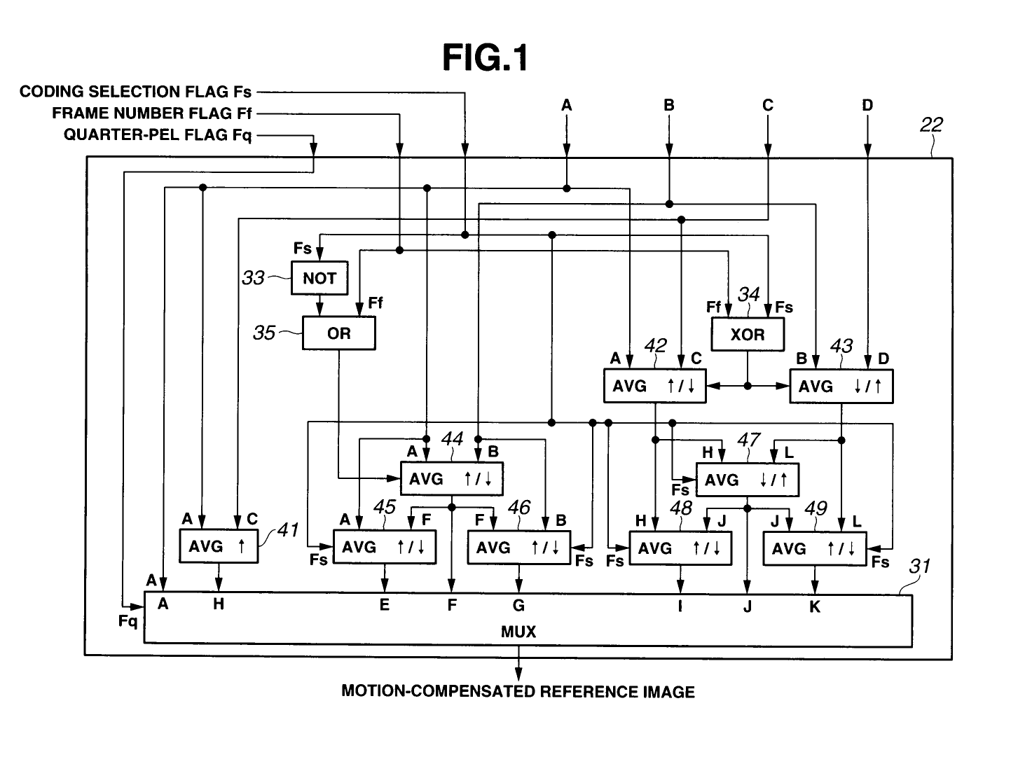

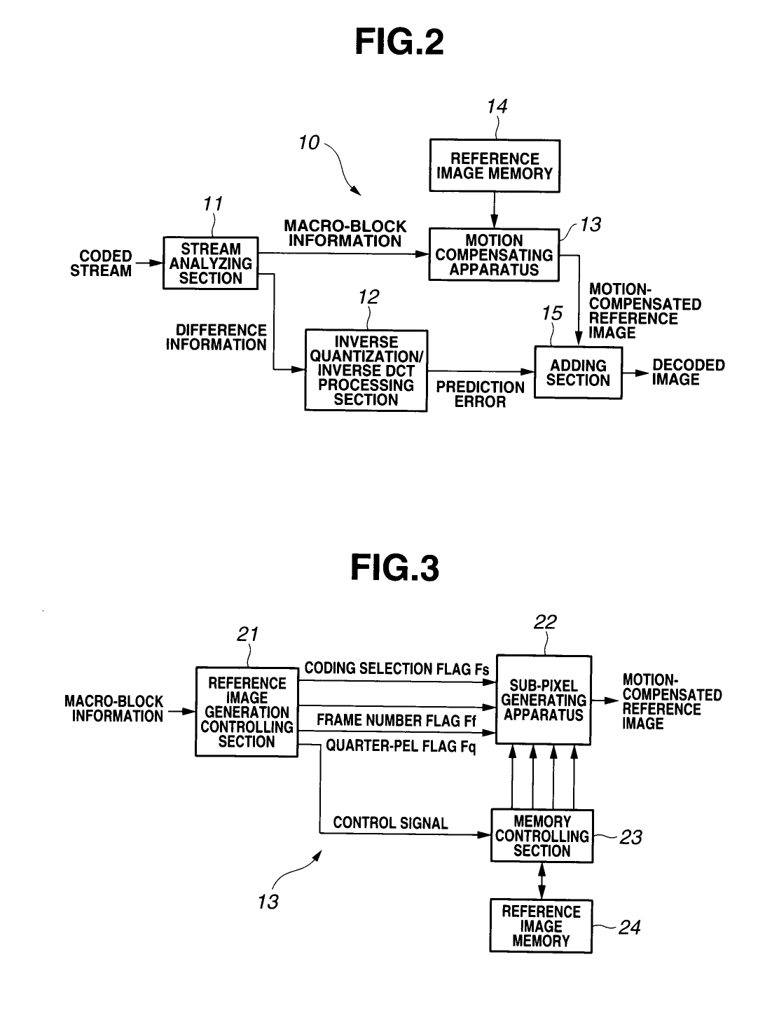

Hereinafter, an embodiment of the present invention will be described in detail with reference to the drawings. FIG. 1 is a block diagram showing a sub-pixel generating apparatus according to an embodiment of the present invention. The present embodiment shows an example in which the sub-pixel generating apparatus has been applied to a motion compensating apparatus. Moreover, FIG. 2 is a block diagram showing a configuration of a moving image decoding apparatus in which the motion compensating apparatus has been incorporated, according to an embodiment of the present invention.

First, the moving image decoding apparatus will be described with reference to FIG. 2. In FIG. 2, a coded stream coded by a moving image coding apparatus (not shown) is inputted to a moving image decoding apparatus 10. The moving image coding apparatus obtains the coded stream by applying a DCT process to a video signal to quantize the video signal, and further applying a variable length coding process to the video signal by using a predetermined variable length coding table. Moreover, the moving image coding apparatus has a difference circuit, an inverse quantization circuit, an inverse DCT circuit, a motion compensation circuit and the like. The moving image coding apparatus can also apply motion-compensated prediction coding to an inputted video signal by obtaining a prediction error between the inputted video signal and reference images before and after a predetermined period of time, and applying the DCT process, a quantization process and the variable length coding process only to the obtained prediction error. It should be noted that detection of a motion vector is performed in units of macro-blocks, and the motion vector is applied with variable length coding, and subsequently, is multiplexed with the video signal applied with the motion-compensated prediction coding, and is outputted.

Such a coded stream applied with the motion-compensated prediction coding is inputted to a stream analyzing section 11 of the moving image decoding apparatus 10. The stream analyzing section 11 can apply a variable length decoding process to the inputted coded stream. The stream analyzing section 11 applies the variable length decoding to the inputted coded stream, and retrieves multiplexed data. For inter-coded macro-blocks, the stream analyzing section 11 extracts information on the motion vector, information on a frame number of the reference image, and information indicating by which method the above described macro-block has been coded if a plurality of coding prediction methods have been employed within a frame, for each macro-block, from the coded stream applied with the variable length decoding, and outputs the extracted information as macro-block information to a motion compensating apparatus 13. Moreover, the stream analyzing section 11 separates information on a difference between a decoding target macro-block and a reference image macro-block from the inputted coded stream, and outputs the difference information to an inverse quantization/inverse DCT processing section 12.

The inverse quantization/inverse DCT processing section 12 applies an inverse quantization process to the inputted difference information, and restores a DCT transform coefficient to the DCT transform coefficient before the quantization process at a coding side. Furthermore, the inverse quantization/inverse DCT processing section 12 applies an inverse DCT process to the DCT transform coefficient to restore the prediction error before the DCT process at the coding side, and outputs the prediction error to an adding section 15.

As will be described later, the motion compensating apparatus 13 generates a motion-compensated reference image based on a reference image stored in a reference image memory 14. In the present case, the motion compensating apparatus 13 determines a blocking position of the reference image to be read from the reference image memory 14, depending on the motion vector, and obtains the motion-compensated reference image. The motion compensating apparatus 13 outputs the generated motion-compensated reference image to the adding section 15. The adding section 15 restores an original image by adding the prediction error and the motion-compensated reference image, and outputs the image as a decoded image.

As described above, a processing amount of a motion compensation process is extremely large. In the present embodiment, sub-pixel generation can be performed with sufficient precision while a calculation amount in a sub-pixel generation process in which the calculation amount particularly increases is suppressed.

FIG. 3 is a block diagram showing an example of a specific configuration of the motion compensating apparatus 13.

The macro-block information from the stream analyzing section 11 is given to a reference image generation controlling section 21. The reference image generation controlling section 21 generates a quarter-pel flag Fq based on the information on the motion vector included in the macro-block information, and outputs the quarter-pel flag Fq to a sub-pixel generating apparatus 22. The motion vector is obtained with ½ pixel precision in MPEG. A ½ pixel position designated by the motion vector corresponds to a ¼ pixel position in the above described half-decoding. The motion vector includes information indicating an integer pixel position and information indicating a fractional pixel position. The quarter-pel flag Fq is generated based on the information on the fractional pixel position in the motion vector, and is information indicating a pixel position with a fractional pixel precision.

The reference image generation controlling section 21 generates a coding selection flag Fs based on the information indicating the prediction method by which the above described macro-block has been coded, and outputs the coding selection flag Fs to the sub-pixel generating apparatus 22. A macro-block may have been coded using multiple predictions, and for each of these a reference image generation controlling section 21 will provide the Fs flag value. The coding selection flag Fs is a one-bit flag indicating any one of two coding prediction cases. Moreover, the reference image generation controlling section 21 generates a one-bit frame number flag Ff indicating whether the frame number is an even number or an odd number, based on the information on the frame number of the reference image, and outputs the frame number flag Ff to the sub-pixel generating apparatus 22. It should be noted that the frame number is a number depending on an order of transmitting each frame in the coded stream.

The reference image generation controlling section 21 outputs a control signal to a memory controlling section 23, based on the information on the motion vector included in the macro-block information. The memory controlling section 23 is controlled by the reference image generation controlling section 21 to read the reference image from a reference image memory 24. In other words, the memory controlling section 23 reads the reference image in a range designated by the information on the integer pixel position in the motion vector, and outputs the reference image to the sub-pixel generating apparatus 22.

As will be described later, the reference image read from the memory controlling section 23 is given to the sub-pixel generating apparatus 22. The sub-pixel generating apparatus 22 generates a sub-pixel based on the coding selection flag Fs, the frame number flag Ff and the quarter-pel flag Fq, and outputs the sub-pixel. The sub-pixel generating apparatus 22 can generate the sub-pixel, for example, corresponding to ¼ pixel precision. For example, if a reference image for the half-decoding, that is, a reference image thinned to ½ in a horizontal direction is stored in the reference image memory 24, and precision of the motion vector is the ½ pixel precision, the sub-pixel generating apparatus 22 can generate pixel values at a thinned pixel position and the ½ pixel position. Moreover, for example, if a reference image which has not been thinned is stored in the reference image memory 24, and the precision of the motion vector is the ¼ pixel precision, the sub-pixel generating apparatus 22 can generate pixel values at the ½ pixel position and the ¼ pixel position.

In the MPEG or the like, the motion vector with the ½ pixel precision is obtained for each macro-block. If the motion vector indicates the integer pixel position, the sub-pixel generating apparatus 22 may read the macro-block of the reference image depending on the motion vector, from the reference image memory 24, and directly output the macro-block. If the motion vector indicates the fractional pixel position, the sub-pixel generating apparatus 22 obtains each sub-pixel of the motion-compensated reference image by an interpolation process by using each pixel of the reference image read from the reference image memory 24.

Now, it is assumed that the pixel values at two integer pixel positions used in the interpolation process are x and y. In the present case, in the MPEG or the like, a sub-pixel Ps is obtained by the following Equation (1).

Ps=[(x+y+1)/2] (1)

where [ ] denotes a process configured to truncate a fractional part.

Rounding errors are accumulated due to the truncation process as described above. In the truncation process of Equation (1), an integer is obtained by adding 0.5 to an average of x and y. Therefore, hereinafter, the truncation process of Equation (1) is referred to as “round-up process in an average value calculation” or simply referred to as “round-up process”. In the present embodiment, the sub-pixel generating apparatus 22 obtains the sub-pixel Ps not only with the round-up process according to the above described Equation (1), but also with a round-down process in the average value calculation (or simply referred to as “round-down process”) of the following Equation (2).

Ps=[(x+y)/2] (2)

In the present embodiment, the sub-pixel generating apparatus 22 performs switching between the round-up process of the above described Equation (1) and the round-down process of the above described Equation (2), in the following four cases (I) to (IV), and obtains the sub-pixel. According to the processes, the sub-pixel generating apparatus 22 prevents the accumulation of the rounding errors.

(I) Switching between calculations of the above described Equations (1) and (2) is performed within a screen.

(II) If a plurality of the average value calculations are performed, the calculations of the above described Equations (1) and (2) are combined to obtain the sub-pixel.

(III) The switching between the calculations of the above described Equations (1) and (2) is performed for each frame.

(IV) The switching between the calculations of the above described Equations (1) and (2) is performed for each of a plurality of prediction methods set for one screen.

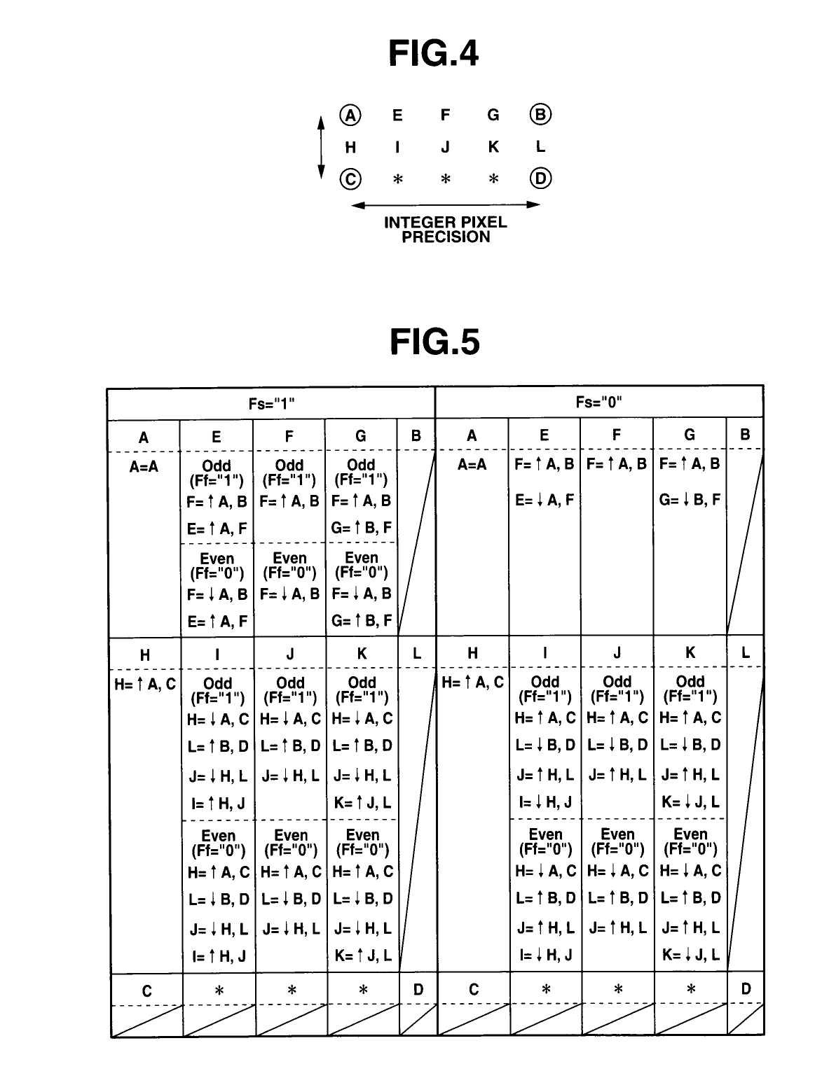

FIGS. 4 and 5 are explanatory diagrams for explaining the sub-pixel generating apparatus 22. FIG. 4 shows a positional relationship between the pixels of the reference image and pixels to be generated. FIG. 5 is a summary of a process in the sub-pixel generating apparatus 22.

Hereinafter, a sub-pixel generating method in the present embodiment will be described with reference to FIGS. 4 and 5.

Circle marks of FIG. 4 denote pixels A to D at the integer pixel positions of the reference image. In FIG. 4, pixels F, H, J and L are pixels at the ½ pixel positions, and pixels E, G, I and K are pixels at the ¼ pixel positions. The pixels F, H, J, L, E, G, I and K are obtained by calculations for the pixels A to D. Calculation methods in the present case are shown by FIG. 5. In FIG. 5, “↑” denotes the round-up process of the above described Equation (1) for two pixel values following “↑”. “↓” denotes the round-down process of the above described Equation (2) for two pixel values following “↓”.

In FIG. 5, ways to obtain the sub-pixel have been classified by four kinds of pixels, that is, the pixel A at the integer pixel position, the pixel H obtained by the interpolation process in a vertical direction, the pixels E, F and G obtained by the interpolation process in the horizontal direction, and the pixels I, J and K obtained by the interpolation process in the horizontal and vertical directions.

In the MPEG or the like, two prediction coding methods may be employed within the frame and two motion vectors may be obtained. In FIG. 5, A to L in a left column surrounded by a thick-bordered box and A to L in a right column surrounded by a thick-bordered box show calculations for a first motion vector and calculations for a second motion vector, respectively, in a case where the two prediction coding methods have been employed within the frame and the two motion vectors have been obtained, respectively (corresponding to the above described (IV)). The above described coding selection flag Fs indicates selection thereof. For example, the coding selection flag Fs of “1” indicates that the calculations in the left column of FIG. 5 are performed, and the coding selection flag Fs of “0” indicates that the calculations in the right column of FIG. 5 are performed. It should be noted that if only one prediction coding method has been employed within the frame, for example, the calculations in the left column are employed.

Moreover, the calculations in the left column and the calculations in the right column of FIG. 5 are processes which are generally equivalent to each other, except that the calculation methods thereof have been set to have inverse rounding error accumulation directions. Therefore, the calculations in the right column may be employed for the first motion vector, and the calculations in the left column may be employed for the second motion vector.

Moreover, Odd and Even in FIG. 5 show processes depending on whether the frame number indicated by the frame number flag Ff is the odd number or the even number, respectively. For example, the frame number flag Ff of “1” indicates an odd frame (Odd), and the frame number flag Ff of “0” indicates an even frame (Even). As shown with Odd and Even in FIG. 5, the sub-pixel generating apparatus 22 performs the switching between the round-up process and the round-down process, between in the even frame and in the odd frame (corresponding to the above described (III)). Thereby, the accumulation of the rounding errors is prevented.

Note that it is apparent that similar effects can be obtained if the round-up process and the round-down process in FIG. 5 are inversely set in Odd and Even.

For example, as shown in F in the left column of FIG. 5, the sub-pixel generating apparatus 22 obtains the pixel F at the ½ pixel position with the round-up process for the pixel values of the pixels A and B in the odd frame, while obtaining the pixel F at the ½ pixel position with the round-down process for the pixel values of the pixels A and B in the even frame.

In a portion with a small motion in the image, each macro-block at the same position in a series of temporally continuous images is often continuously used as the reference image. In other words, in the portion with the small motion, the rounding errors are easily accumulated, and the round-up and round-down processes have significant adverse effects on image quality. Consequently, switching between the round-up process and the round-down process is performed for the same pixel of continuous frames so that such rounding errors are negated. Thereby, the accumulation of the rounding errors can be suppressed, and image degradation can be prevented.

It should be noted that, as shown in E in the left column of FIG. 5, the sub-pixel generating apparatus 22 generates the pixel E at the ¼ pixel position by using the pixel A at the integer pixel position and the pixel F at the ½ pixel position obtained by the interpolation process. In the present case, it is conceivable that the rounding errors of the pixel F have been offset by the processes in the odd frame and the even frame. Therefore, the pixel E is obtained with the round-up process both in the odd and even frames. It should be noted that the pixel E may be obtained with the round-down process for the pixel A and the pixel F.

Moreover, as shown in I in the left column of FIG. 5, the sub-pixel generating apparatus 22 obtains the pixel H by using the pixels A and C, obtains the pixel L by using the pixels B and D, obtains the pixel J by using the pixels H and L, and obtains the pixel I by using the pixels H and J. In the present case, the pixels H and J are obtained with the round-down process, and the pixels L and I are obtained with the round-up process. In other words, the sub-pixel generating apparatus 22 combines the round-up process and the round-down process to obtain one sub-pixel I (corresponding to the above described (II)). Thereby, the accumulation of the rounding errors is prevented.

It should be noted that a pixel position of the pixel L corresponds to a pixel position of the pixel H in FIG. 4, in a pixel area with an integer pixel precision on the right side of the pixel area with an integer precision of FIG. 4. Therefore, the accumulation of the rounding errors can be suppressed in terms of the continuous frames by obtaining one of the pixels H and L which are obtained when the pixel J is generated, with the round-up process, and obtaining the other one of the pixels H and L with the round-down process.

Moreover, as shown in H in the left column of FIG. 5, the sub-pixel generating apparatus 22 has obtained the pixel F at the ½ pixel position with the round-up process for the pixel values of the pixels A and B in the odd frame, while the sub-pixel generating apparatus 22 obtains the pixel H with the round-down process for the pixel values of the pixels A and C also in the odd frame (corresponding to the above described (I)). Moreover, as shown in the left column of FIG. 5, the sub-pixel generating apparatus 22 obtains the pixel L with the round-up process for the pixel values of the pixels B and D in the odd frame. As described above, the sub-pixel generating apparatus 22 performs the switching between the round-up process and the round-down process for the sub-pixel generation depending on the position on the screen, and thereby reduces the adverse effects on the image quality due to the rounding errors.

It should be noted that FIG. 5 shows an example of a combination of the processes which can suppress the adverse effects on the image quality due to the rounding errors most in a particular image, and it is apparent that various combinations of the processes can be selected without being limited to FIG. 5. For example, in FIG. 5, although the sub-pixel generating apparatus 22 obtains the pixel H with the round-up process by using the pixels A and C regardless of the coding selection flag Fs and the frame number flag Ff, the pixel H may be obtained with the round-up process in one case, and with the round-down process in the other case, according to the above described (III), (IV) or the like.

The sub-pixel generating apparatus 22 of FIG. 1 shows an example of a circuit configured to realize the process of FIG. 5.

In FIG. 1, the quarter-pel flag Fq from the reference image generation controlling section 21 is provided to a MUX 31 of the sub-pixel generating apparatus 22. Moreover, the coding selection flag Fs is provided to a NOT circuit 33 and an XOR circuit 34 of the sub-pixel generating apparatus 22. Moreover, the frame number flag Ff is provided to the XOR circuit 34 and an OR circuit 35 of the sub-pixel generating apparatus 22. Moreover, the pixel values of the pixels A, B, C and D at four integer pixel positions are also inputted to the sub-pixel generating apparatus 22 from the memory controlling section 23.

Moreover, the sub-pixel generating apparatus 22 has 2-input 1-output computing units 41 to 49. “AVG↑” in each computing unit of FIG. 1 indicates that the round-up process of Equation (1) is performed for two inputs x and y. Moreover, “AVG↑/↓” indicates that the round-up process of Equation (1) is performed if “1” is applied as a selection signal, and the round-down process of Equation (2) is performed if “0” is applied. Moreover, similarly, “AVG↓/↑” indicates that the round-down process of Equation (2) is performed if “1” is applied as the selection signal, and the round-up process of Equation (1) is performed if “0” is applied.

The pixel value of the pixel A read by the memory controlling section 23 is given to the MUX 31 and the computing units 41, 42 and 44. Moreover, the pixel value of the pixel B is given to the computing units 43 and 44. Moreover, the pixel value of the pixel C is given to the computing units 41 and 42. Moreover, the pixel value of the pixel D is given to the computing unit 43.

If the coding selection flag Fs=“0” (in the right column of FIG. 5), the NOT circuit 33 outputs “1”, the OR circuit 35 always outputs “1”, and the computing unit 44 performs the round-up process to obtain the pixel F.

If the coding selection flag Fs=“1” (in the left column of FIG. 5), the NOT circuit 33 outputs “0”, and the output of the OR circuit 35 is identical to the frame number flag Ff. In the odd frame (Odd in the left column of FIG. 5), the frame number flag Ff=“1”, and the computing unit 44 performs the round-up process by using the pixels A and B to generate the pixel F. Moreover, the computing unit 45 generates the pixel E with the round-up process by using the pixels A and F, based on the selection signal of “1”. The computing unit 46 also generates the pixel G with the round-up process by using the pixels B and F, based on the selection signal of “1”.

If the frame number flag Ff=“0” (Even in the left column of FIG. 5), the computing unit 44 performs the round-down process by using the pixels A and B to generate the pixel F. Moreover, in the present case, the computing unit 45 generates the pixel E with the round-up process by using the pixels A and F, and the computing unit 46 generates the pixel G with the round-up process by using the pixels B and F, respectively.

The XOR circuit 34 obtains an exclusive OR of the frame number flag Ff and the coding selection flag Fs. When the coding selection flag Fs=“1” and the frame number flag Ff=“1” (the odd frame) (Odd in the left column of FIG. 5), the XOR circuit 34 outputs “0”, the computing unit 42 performs the round-down process by using the pixels A and C to generate the pixel H, and the computing unit 43 performs the round-up process by using the pixels B and D to generate the pixel L. The selection signal of “1” is given to the computing unit 47, and the computing unit 47 generates the pixel J with the round-down process by using the generated pixels H and L. Furthermore, the selection signal of “1” is given to the computing units 48 and 49, and the computing unit 48 generates the pixel I with the round-up process by using the generated pixels H and J, and the computing unit 49 generates the pixel K with the round-up process by using the pixels J and L, respectively.

Both in a case where Fs=“1” and Ff=“1” as described above (Odd in the left column of FIG. 5), and in a case where Fs=“0” and Ff=“0”, that is, a case of Even in the right column of FIG. 5, operations of the computing units 42 and 43 are identical. The round-up process and the round-down process are reversed in operations of the computing units 47 to 49, in the respective cases.

Moreover, both in a case where Fs=“1” and Ff=“0” (Even in the left column of FIG. 5), and in a case where Fs=“0” and Ff=“1” (Odd in the right column of FIG. 5), the operations of the computing units 42 and 43 are identical to each other. The round-up process and the round-down process in the computing units 47 to 49 are switched depending on a value of the frame number flag Ff, in the respective cases.

It should be noted that the computing unit 41 always generates the pixel H with the round-up process by using the pixels A and C, regardless of the coding selection flag Fs and the frame number flag Ff. Outputs of the computing units 41, 44 to 49 are provided as the pixel values of the pixels H, F, E, G, J, I and K to the MUX 31, respectively. The MUX 31 selects the pixel value at the pixel position designated by the quarter-pel flag Fq, and outputs the pixel value as the motion-compensated reference image. As described above, the process shown in FIG. 5 is performed to obtain each pixel.

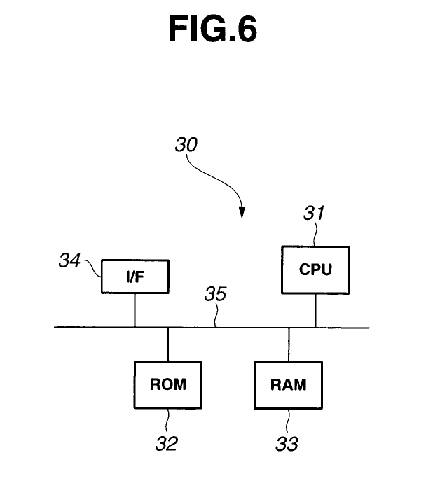

Next, an example in which the process shown in FIG. 5 is realized by software will be described. FIG. 6 is a block diagram showing a sub-pixel generating apparatus 30 configured to realize the process shown in FIG. 5 by software. The sub-pixel generating apparatus of FIG. 6 is an information processing apparatus configured with a central processing unit (CPU) 31, a ROM 32, a RAM 33, an interface section (hereinafter, referred to as “I/F”) 34 and the like, and can be configured by using a personal computer (PC) or the like. A processing program for the sub-pixel generation process, and the like have been stored in the ROM 32. The RAM 33 is a work storage area for the CPU 31. The I/F 34 is an interface to an inputting device (not shown) or the like. The CPU 31, the ROM 32, the RAM 33 and the I/F 34 are connected via a bus 35.

The round-up process of the above described Equation (1) is obtained by shifting (x+y+1) to the right by one bit on the computer. Hereinafter, the process is described as (x+y+1) >>1. Moreover, the round-down process of the above described Equation (2) is obtained by shifting (x+y) to the right by one bit on the computer. Hereinafter, the process is described as (x+y) >>1.

Furthermore, in order to clarify software processing, the above processes are described as follows.

avg(x, y)=(x+y+1)>>1 . . . (the round-up process)

avg_{DOWN}(x, y)=(x+y)>>1 . . . (the round-down process)

Moreover, as described above, the switching between the round-up process and the round-down process is also performed depending on whether the frame number is Odd or Even. Consequently, in consideration of the above point, the following descriptions are also employed.

avg_{VROUND}(x, y)=(x+y+vround)>>1

avg_{g1-VROUND}(x, y)=(x+y+1-vround)>>1

It should be noted that, in a case of Odd, vround=1, and in a case of Even, vround=0. In other words, avg_{VROUND} indicates the round-up process with Ff=1, and avg_{1-VROUND} indicates the round-down process with Ff=1.

The ways to obtain the sub-pixel can be classified into four kinds as shown in FIG. 5, that is, (a) the way to obtain the pixel A at the integer pixel position, (b) the way to obtain the pixel H by the interpolation process in the vertical direction, (c) the way to obtain the pixels E, F and G by the interpolation process in the horizontal direction, and (d) the way to obtain the pixels I, J and K by the interpolation process in the horizontal and vertical directions.

(a) The way to obtain the pixel A at the integer pixel position

The pixel A is obtained by the following Equation (3). It should be noted that the pixel value of the pixel A is A, coordinates of the reference image at the same position as the pixel A are (x, y), pel_ref[a][b] denote the pixel values at coordinates (a, b) of the reference image, and vec[1] and vec[0] denote a vertical component and a horizontal component of the motion vector, respectively.

A=pel_{—ref[}y+vec[1]][x+vec[0]] (3)

(b) The way to obtain the pixel H by the interpolation process in the vertical direction

Coordinates of the pixel H are obtained by adding 1 to the coordinate of the pixel A in the vertical direction, and the pixel value H is obtained by the following Equation (4).

$$\begin{matrix}H = avg ( A , C ) \\ = \frac{\{ \begin{matrix}pel\_ref [ y + vec [ 1 ] ] [ x + vec [ 0 ] ] + \\ pel\_ref [ y + vec [ 1 ] + 1 ] [ x + vec [ 0 ] ]\end{matrix} \}}{2}\end{matrix} \qquad ( 4 )$$

(c) The way to obtain the pixels E, F and G by the interpolation process in the horizontal direction

The pixel values E, F and G of the pixels E, F and G are obtained by the following Equations (5) and (6).

In the present case, the equations for the calculations are different depending on the coding selection flag Fs.

In a case of the coding selection flag Fs=0

$$\begin{matrix}\begin{matrix}F = avg ( A , B ) \\ = \frac{\{ \begin{matrix}pel\_ref [ y + vec [ 1 ] ] [ x + vec [ 0 ] ] + \\ pel\_ref [ y + vec [ 1 ] ] \\ [ x + vec [ 0 ] + 1 ]\end{matrix} \}}{2}\end{matrix} & ( 5 ) \\ E = {avg}_{DOWN} ( A , F ) \\ G = {avg}_{DOWN} ( B , F ) & \end{matrix}$$

In a case of the coding selection flag Fs=1

$$\begin{matrix}\begin{matrix}F = avg ( A , B ) \\ = \frac{\{ \begin{matrix}pel\_ref [ y + vec [ 1 ] ] [ x + vec [ 0 ] ] + \\ pel\_ref [ y + vec [ 1 ] ] [ x + vec [ 0 ] + 1 ] + vround\end{matrix} \}}{2}\end{matrix} & ( 6 ) \\ E = avg ( A , F ) \\ G = avg ( B , F ) & \end{matrix}$$

(d) The way to obtain the pixels I, J and K by the interpolation process in the horizontal and vertical directions

The pixel values I, J and K of the pixels I, J and K are obtained by the following Equations (7) and (8).

Also in the present case, the equations for the calculations are different depending on the coding selection flag Fs.

In the case of the coding selection flag Fs=0

$$\begin{matrix}\begin{matrix}H = {avg}_{VROUND} ( A , C ) \\ = \frac{\{ \begin{matrix}pel\_ref [ y + vec [ 1 ] ] [ x + vec [ 0 ] ] + \\ pel\_ref [ y + vec [ 1 ] + 1 ] [ x + vec [ 0 ] ] + \\ vround\end{matrix} \}}{2}\end{matrix} & ( 7 ) \\ \begin{matrix}L = {avg}_{1 - VROUND} ( B , D ) \\ = \frac{\{ \begin{matrix}pel\_ref [ y + vec [ 1 ] ] [ x + vec [ 0 ] + 1 ] + \\ pel\_ref [ y + vec [ 1 ] + 1 ] [ x + vec [ 0 ] + 1 ] + 1 - vround\end{matrix} \}}{2}\end{matrix} & \\ J = avg ( H , L ) \\ I = {avg}_{DOWN} ( H , J ) \\ K = {avg}_{DOWN} ( J , J ) & \end{matrix}$$

In the case of the coding selection flag Fs=1

$$\begin{matrix}\begin{matrix}H = {avg}_{1 - VROUND} ( A , C ) \\ = \frac{\{ \begin{matrix}pel\_ref [ y + vec [ 1 ] ] [ x + vec [ 0 ] ] + \\ pel\_ref [ y + vec [ 1 ] + 1 ] [ x + vec [ 0 ] ] + 1 - vround\end{matrix} \}}{2}\end{matrix} & ( 8 ) \\ \begin{matrix}L = {avg}_{VROUND} ( B , D ) \\ = \frac{\{ \begin{matrix}pel\_ref [ y + vec [ 1 ] ] [ x + vec [ 0 ] + 1 ] + \\ pel\_ref [ y + vec [ 1 ] + 1 ] \\ [ x + vec [ 0 ] + 1 ] + vround\end{matrix} \}}{2}\end{matrix} & \\ J = {avg}_{DOWN} ( H , L ) \\ I = avg ( H , J ) \\ K = avg ( J , J ) & \end{matrix}$$

The above described calculations enable the process shown in FIG. 5.

As described above, in the present embodiment, as the interpolation process configured to obtain the sub-pixel, not only the round-up process but also the round-down process is employed. The switching between the round-up process and the round-down process is performed, or the combination of the round-up process and the round-down process is used, within the screen, for each frame, and for each prediction coding method. Thereby, the accumulation of the rounding errors is prevented, and improvement in the image quality is attempted.

It should be noted that the present invention is not limited to the above described embodiment, and various variations are possible. For example, logic values of the coding selection flag Fs and the frame number flag Ff in the above description may be reversed. Also in the present case, it is apparent that each sub-pixel can be obtained by similar calculations.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A sub-pixel generating apparatus, comprising:
a first calculating section configured to execute an average value calculation for pixel values of a plurality of pixels in an image, with a round-up process;
a second calculating section configured to execute the average value calculation for the pixel values of the plurality of pixels in the image, with a round-down process; and
a selecting section configured to generate an interpolated pixel to be interpolated in the image, by at least one selection process among a first selection process configured to select the round-up process or the round-down process depending on a position of the interpolated pixel, a second selection process configured to select the round-up process or the round-down process for each coding prediction method set for the image, and a third selection process configured to select the round-up process or the round-down process for each average value calculation if the interpolated pixel is obtained by a plurality of the average value calculations.

2. The sub-pixel generating apparatus according to claim 1, wherein
the selecting section is configured to be able to execute a fourth selection process configured to select the round-up process or the round-down process for each frame of the image.

3. The sub-pixel generating apparatus according to claim 1, wherein
the selecting section is configured to select the round-up process or the round-down process depending on whether the position of the interpolated pixel is a first position obtained by an interpolation process in a vertical direction by using the pixels in the image, a second position obtained by the interpolation process in a horizontal direction by using the pixels in the image, or a third position obtained by the interpolation process in the horizontal and vertical directions by using the pixels in the image.

4. The sub-pixel generating apparatus according to claim 1, wherein
the selecting section is configured to execute the first selection process based on information on a motion vector, and execute the second selection process based on information on the coding prediction method.

5. The sub-pixel generating apparatus according to claim 4, wherein
the selecting section is configured to execute the first selection process based on information on a fractional pixel position included in the information on the motion vector.

6. The sub-pixel generating apparatus according to claim 1, wherein
the selecting section is configured to perform switching between the round-up process and the round-down process for each frame if the position of the interpolated pixel is a 1/2 pixel position.

7. The sub-pixel generating apparatus according to claim 1, wherein
the selecting section is configured to set the round-up process in one of two average value calculations, and set the round-down process in the other one of the two average value calculations, if the position of the interpolated pixel is a 1/4 pixel position.

8. The sub-pixel generating apparatus according to claim 1, wherein
the selecting section is configured to change a method configured to select the round-up process and the round-down process, between in two average value calculations in an odd frame and in the two average value calculations in an even frame, if the position of the interpolated pixel is a 1/4 pixel position.

9. A sub-pixel generating method configured to generate an interpolated pixel to be interpolated in an image, by a first calculating section configured to execute an average value calculation for pixel values of a plurality of pixels in the image, with a round-up process, and a second calculating section configured to execute the average value calculation for the pixel values of the plurality of pixels in the image, with a round-down process,
wherein the interpolated pixel is generated by at least one selection process among a first selection process configured to select the round-up process or the round-down process depending on a position of the interpolated pixel, a second selection process configured to select the round-up process or the round-down process for each coding prediction method set for the image, and a third selection process configured to select the round-up process or the round-down process for each average value calculation if the interpolated pixel is obtained by a plurality of the average value calculations.

10. The sub-pixel generating method according to claim 9, wherein
in the generation of the interpolated pixel, a fourth selection process configured to select the round-up process or the round-down process for each frame of the image is possible.

11. The sub-pixel generating method according to claim 9, wherein
in the generation of the interpolated pixel, the round-up process or the round-down process is selected depending on whether the position of the interpolated pixel is a first position obtained by an interpolation process in a vertical direction by using the pixels in the image, a second position obtained by the interpolation process in a horizontal direction by using the pixels in the image, or a third position obtained by the interpolation process in the horizontal and vertical directions by using the pixels in the image.

12. The sub-pixel generating method according to claim 9, wherein
in the generation of the interpolated pixel, the first selection process is executed based on information on a motion vector, and the second selection process is executed based on information on the coding prediction method.

13. A computer-readable storage medium including a program, the program being configured to cause a computer to execute:
a process configured to generate an interpolated pixel to be interpolated in an image, by a first calculation process configured to execute an average value calculation for pixel values of a plurality of pixels in the image, with a round-up process, and a second calculation process configured to execute the average value calculation for the pixel values of the plurality of pixels in the image, with a round-down process,
wherein the program is configured to cause the computer to execute the process configured to generate the interpolated pixel by at least one selection process among a first selection process configured to select the round-up process or the round-down process depending on a position of the interpolated pixel, a second selection process configured to select the round-up process or the round-down process for each coding prediction method set for the image, and a third selection process configured to select the round-up process or the round-down process for each average value calculation if the interpolated pixel is obtained by a plurality of the average value calculations.

14. The storage medium according to claim 13, wherein
the program is configured to be able to cause, in the generation of the interpolated pixel, a fourth selection process configured to select the round-up process or the round-down process for each frame of the image, to be executed.

15. The storage medium according to claim 13, wherein
the program is configured to cause a process configured to perform switching between the round-up process and the round-down process for each frame, to be executed if the position of the interpolated pixel is a 1/2 pixel position.

16. The storage medium according to claim 13, wherein
the program is configured to cause the round-up process to be executed in one of two average value calculations, and cause the round-down process to be executed in the other one of the two average value calculations, if the position of the interpolated pixel is a ¼ pixel position.

17. The storage medium according to claim 13, wherein
the program is configured to cause a process configured to change a method configured to select the round-up process and the round-down process, between in two average value calculations in an odd frame and in the two average value calculations in an even frame, to be executed if the position of the interpolated pixel is a ¼ pixel position.

18. A motion compensating apparatus, comprising:
a sub-pixel generating apparatus including a first calculating section configured to execute an average value calculation for pixel values of a plurality of pixels in an image, with a round-up process; a second calculating section configured to execute the average value calculation for the pixel values of the plurality of pixels in the image, with a round-down process; and a selecting section configured to generate an interpolated pixel to be interpolated in the image, by at least one selection process among a first selection process configured to select the round-up process or the round-down process depending on a position of the interpolated pixel, a second selection process configured to select the round-up process or the round-down process for each coding prediction method set for the image, and a third selection process configured to select the round-up process or the round-down process for each average value calculation if the interpolated pixel is obtained by a plurality of the average value calculations;
a memory controlling section configured to read a reference image from a reference image memory based on a motion vector extracted from a coded stream applied with motion-compensated prediction coding, and give the reference image to the first and second calculating sections; and
a controlling section configured to give the motion vector extracted from the coded stream, to the selecting section for the first selection process, give information on the coding prediction method extracted from the coded stream, to the selecting section for the second selection process, and give information on a frame number extracted from the coded stream, to the selecting section for the third selection process.

19. The motion compensating apparatus according to claim 18, wherein
the selecting section is configured to be able to execute a fourth selection process configured to select the round-up process or the round-down process for each frame of the image, and
the controlling section is configured to give the information on the frame number extracted from the coded stream, to the selecting section for the fourth selection process.

20. The motion compensating apparatus according to claim 18, wherein
the controlling section is configured to control the first selection process based on information on a fractional pixel position included in information on the motion vector.
